(19) United States
(12) Patent Application Publication
(10) Pub. No.: US 2025/0209667 A1
(43) Pub. Date: Jun. 26, 2025

(54) VISUAL MEASUREMENT METHOD AND SYSTEM BASED ON DIGITAL HUMAN MODEL

(71) Applicant: China National Institute of Standardization, Beijing (CN)

(72) Inventors: Yunhong ZHANG, Beijing (CN); Feng SI, Beijing (CN); Yi YANG, Beijing (CN); Guoli LIU, Beijing (CN); Jing ZHAO, Beijing (CN)

(21) Appl. No.: 19/077,451

(22) Filed: Mar. 12, 2025

(30) Foreign Application Priority Data
Jun. 18, 2024 (CN) 202410783466.7

(51) Int. Cl. G06T 7/73; G06T 5/60; G06T 5/70; G06T 7/33; G06T 13/40; G06T 17/00; G06T 19/20

(52) U.S. Cl. CPC G06T 7/75; G06T 5/60; G06T 5/70; G06T 7/344; G06T 13/40; G06T 17/00; G06T 19/20; G06T 2207/20036; G06T 2207/20081; G06T 2207/20084; G06T 2207/30201; G06T 2219/2016; G06T 2219/2021

(57) ABSTRACT

The present application provides a visual measurement method and system based on a digital human model. The visual measurement method includes the following steps: data acquisition, data matching, and data optimization. According to the present application, a digital human model is constructed from obtained 3D data, pose estimation is performed on the digital human model using a deep learning algorithm to obtain first data, and the first data is preprocessed to obtain second data. Then, the second data is matched and aligned with the digital human model, and a correspondence between the second data and the digital human model is established through key feature point matching and shape registration, to obtain third data. Finally, key feature points are extracted from the third data and optimized through a computer vision algorithm and image processing, and morphological parameters are obtained according to the optimized key feature points.

### CROSS REFERENCE TO RELATED APPLICATION

This patent application claims the benefit and priority of Chinese Patent Application No. 202410783466.7, filed with the China National Intellectual Property Administration on Jun. 18, 2024, the disclosure of which is incorporated by reference herein in its entirety as part of the present application.

### TECHNICAL FIELD

The present disclosure relates to the technical field of artificial intelligence, and in particular, to a visual measurement method and system based on a digital human model.

### BACKGROUND

Digital human modeling emerged with the continuous development of technologies such as computer graphics, computer vision, and artificial intelligence. By creating a three-dimensional (3D) digital model of the human body, it can accurately reproduce the shape and structure of the human body. With the maturation and widespread adoption of 3D scanning technology, digital human modeling has found extensive applications in various fields such as healthcare, fashion, and entertainment. Digital human modeling enables precise measurement and analysis of body dimensions, shapes, and poses, providing strong support for research and applications in related fields.

According to current measurement methods and devices, a pedestrian bounding box of a current frame and bounding box motion vectors of a plurality of historical frames are obtained. A feature extraction sub-network of a pedestrian tracking model performs feature extraction on a target pedestrian image within the pedestrian bounding box, to obtain a latent feature vector of the target pedestrian image. Then, a face detection model extracts a face image set, which is subsequently clustered by a face recognition model. However, there is an issue of low efficiency in the testing process, making it particularly important to improve testing efficiency.

For example, a disclosure patent, with the publication number of CN110298238B and entitled PEDESTRIAN VISUAL TRACKING METHOD, MODEL TRAINING METHOD AND DEVICE, APPARATUS AND STORAGE MEDIUM, discloses a method including: obtaining a pedestrian bounding box of a current frame and bounding box motion vectors of a plurality of historical frames; performing, by a feature extraction sub-network of a pedestrian tracking model, feature extraction on a target pedestrian image within the pedestrian bounding box, to obtain a latent feature vector of the target pedestrian image; predicting, by a prediction sub-network of the pedestrian tracking model, a bounding box motion vector of the current frame according to the latent feature vector and the bounding box motion vectors of the plurality of historical frames; predicting a pedestrian bounding box of a frame after the current frame according to the pedestrian bounding box of the current frame and the bounding box motion vector of the current frame; if the frame after the current frame corresponds to a pedestrian annotation box, calculating an overlap rate between the pedestrian annotation box and the pedestrian bounding box of the frame after the current frame; if the overlap rate is less than a preset overlap threshold, storing the pedestrian annotation box as the pedestrian bounding box of the frame after the current frame; said predicting, by a prediction sub-network of the pedestrian tracking model, a bounding box motion vector of the current frame according to the latent feature vector and bounding box motion vectors of the plurality of historical frames includes: processing the latent feature vector and bounding box motion vectors of the plurality of historical frames as input vectors; performing, by the prediction sub-network of the pedestrian tracking model, full connection processing and normalization processing on the input vectors, to obtain a plurality of motion probabilities in a one-to-one correspondence with a plurality of motion components; performing, by the prediction sub-network of the pedestrian tracking model, full connection processing on the plurality of motion probabilities to obtain a target probability of the pedestrian bounding box corresponding to the plurality of motion components; generating the bounding box motion vector of the current frame according to the target probability greater than a preset target threshold, where the bounding box motion vector includes information of the motion components corresponding to the target probability.

For example, a disclosure patent, with the publication number of CN115471893B and entitled METHOD AND DEVICE FOR TRAINING FACE RECOGNITION MODEL AND FACE RECOGNITION, discloses a method including: obtaining a video including face images of different age group; selecting, by a face detection model from a video, video frames containing face images, and then performing image matting to obtain a face image set; determining, through key point detection, whether the face images are complete, and filtering out occluded or incomplete face images, or repairing occluded or incomplete face images; clustering, by a first face recognition model, the face image set to obtain a first clustering result; and training, according to the first clustering result, the first face recognition model with a same type of face images and different types of face images as positive samples and negative samples respectively, to obtain a second face recognition model after training. Said obtaining a video including face images of different age groups includes: searching, in a user-authorized video library using a keyword, for a video showing face images in different age groups of at least one person. Said training, according to the first clustering result, the first face recognition model with a same type of face images and different types of face images as positive samples and negative samples respectively includes: converting voice frames of the video into a text information set; identifying character names from the text information set; determining a face image corresponding to each character name according to a position of a voice frame corresponding to each character name in the video; and determining face images corresponding to a same character name as the positive samples.

However, during the implementation of the technical solutions in the embodiments of the present application, the above technology has at least the following technical problems:

According to the current technology, a pedestrian bounding box of a current frame and bounding box motion vectors of a plurality of historical frames are obtained. A feature extraction sub-network of a pedestrian tracking model performs feature extraction on a target pedestrian image within the pedestrian bounding box, to obtain a latent feature vector of the target pedestrian image, and obtain a video containing face images in different age groups. Then, a face detection model extracts a face image set, which is subsequently clustered by a face recognition model. However, there is an issue of low efficiency in the testing process.

### SUMMARY

Embodiments of the present application provide a visual measurement method and system based on a digital human model, to resolve the problem of low efficiency in the testing process in the prior art, thereby improving the efficiency of the testing process.

The embodiments of the present application provide a visual measurement method based on a digital human model, including the following steps: S1: constructing a digital human model according to obtained 3D data, performing pose estimation on the digital human model to obtain first data, and preprocessing the first data to obtain second data; S2: matching and aligning the second data with the digital human model, and establishing a correspondence between the second data and the digital human model through key feature point matching and shape registration, to obtain third data; and S3: extracting key feature points from the third data and optimizing the key feature points through a computer vision algorithm and image processing, and finally obtaining morphological parameters according to the optimized key feature points.

Further, said obtaining first data includes the following steps: constructing a preset data set based on existing data, where the existing data includes morphological measurement data, facial feature data, and motion and expression data, and the preset data set is a set of digital human model images with preset poses and corresponding pose annotation information; training and predicting a preset model using the constructed preset data set, to obtain a prediction result of the model pose estimation; and after the training, inputting pose information of the digital human model into the trained preset model, and outputting predicted key feature points, to obtain the first data.

Further, said constructing a digital human model specifically includes the following steps: designing a basic image of the digital human model using 3D modeling software, and performing texture mapping processing on the digital human model, where the texture mapping processing includes adding colors, materials, and textures; performing key feature point binding on the digital human model to create a corresponding motion mode and motion range, and adjusting positions and weights of the key feature points in the digital human model during the key feature point binding, where the weight is a parameter for quantifying an influence degree of the key feature point on the digital human model; and adding expression animation corresponding to the digital human model using 3D animation software, and performing rendering enhancement on the digital human model using preset rendering settings, where the preset rendering settings include adjusting lighting, adjusting shadows, adding background, and adding environment.

Further, said preprocessing includes denoising, enhancement, and correction; the denoising includes weakening a noise component in the first data using a machine learning algorithm; the enhancement includes improving contrast, brightness, and clarity of the first data through sharpening, to increase a proportion of high-frequency components in the first data; and the correction includes correcting the first data through radiation correction to eliminate distortion and errors of the first data.

Further, the contrast is calculated using the following formula:

$$C = \frac{1}{M * N} * {\sum }_{i = 1}^{F} {\sum }_{j = 1}^{H} [ \sqrt{{( {Δx}_{ij} )}^{2} + ( Δ {y}_{{ij}^{2}} )} ] ;$$

C is the contrast, M is a pixel width of the first data, N is a pixel height of the first data, ΔXᵢⱼ is a difference of a gradient value of a pixel (i, j) in the first data in a horizontal direction, ΔYᵢⱼ is a difference of a gradient value of the pixel (i, j) in the first data in a vertical direction, i is a number of the pixel in the first data in the horizontal direction, i=1, 2, 3, . . . , F, F is a total number of pixels in the first data in the horizontal direction, j is a number of the pixel in the first data in the vertical direction, j=1, 2, 3, . . . , H, and H is a total number of the pixels in the first data in the vertical direction.

Further, the gradient value is calculated using the following formula:

$$G ( i , j ) = \sqrt{{\sum }_{d ∈ D} {\vert f [ K ( i , j ) - K ( p + {d}_{y} , q + {d}_{x} ) ] \vert}^{h}} ;$$

G(i, j) is the gradient value of the pixel (i, j) in the first data, D is a direction set of the pixels in the first data, d is a direction of the pixel in the first data, i is an abscissa of the pixel in the first data, j is an ordinate of the pixel in the first data, d is an x component of the pixel in a d^{th} direction in the first data, d_{y} is a y component of the pixel in the d^{th} direction in the first data, and h is a preset factor.

Further, said matching and aligning the second data with the digital human model specifically includes the following steps: generating preset feature points through the digital human model, where the preset feature points correspond to the key feature points, and performing feature point matching on feature points in the second data using a feature matching algorithm and the preset feature points, where the feature point matching represents matching between the feature points in the second data and the preset feature points; performing spatial transformation on the digital human model according to a result of the feature point matching, where the spatial transformation includes translation, rotation, and scaling, and the spatial transformation is used to align the digital human model with a pose and position corresponding to the second data; and adjusting a pose and shape of the digital human model using a 3D deformation method and an optimization algorithm.

Further, said extracting and optimizing key feature points specifically includes the following steps: obtaining a preset area and positions of preset feature points using a target detection method, and filtering and correcting the preset feature points with reference to structural information of the digital human model and priori knowledge; extracting the preset feature points again using a convolutional neural network model, and training the digital human model to learn representation and positioning methods of the key feature points to enable recognition of the key feature points by the digital human model; and detecting an overlap degree between the key feature points using a non-maximum suppression method, to remove redundancy and overlap, and verifying and evaluating accuracy and reliability of the extracted key feature points by using a preset data set.

Further, the non-maximum suppression method includes the following steps: ranking, based on confidence, detection boxes generated after applying a convolutional neural network, selecting a preset detection box as a current suppression object, and calculating an overlap degree between each remaining detection box and the current suppression object, where the overlap degree is calculated using the following formula:

$${R}_{g} = {S}_{g} + \frac{{\sum }_{g = 1}^{G} exp [ - \frac{{( {d}_{g} )}^{2}}{2 {σ}^{2}} ]}{G} + cos {θ}_{g} ;$$

R_{g} is an overlap degree between a g^{th} remaining detection box and the current suppression object, Sg is an intersection over union between the g^{th} remaining detection box and the current suppression object, g is a number of the remaining detection box, g=1, 2, 3, . . . , G, G is a total number of the remaining detection boxes, d_{g} is a distance between the current suppression object and the g^{th} remaining detection box, σ is a standard deviation of a Gaussian kernel, and θ_{g} is a distance-angle relationship between the current suppression object and the g^{th} remaining detection box.

The embodiments of the present application provide a visual measurement system based on a digital human model, including a data acquisition module, a data matching module, and an extraction and optimization module, where the data acquisition module is configured to construct a digital human model according to obtained 3D data, perform pose estimation on the digital human model to obtain first data, and preprocess the first data to obtain second data; the data matching module is configured to match and align the second data with the digital human model, and establish a correspondence between the second data and the digital human model through key feature point matching and shape registration, to obtain third data; and the extraction and optimization module is configured to extract key feature points from the third data and optimize same through a computer vision algorithm and image processing, and finally obtain morphological parameters according to the optimized key feature points.

One or more technical solutions provided in the embodiments of the present application have at least the following technical effects or advantages:
1. Pose estimation is performed on a digital human model using a deep learning algorithm to obtain first data, and the first data is preprocessed to obtain second data, so as to quickly locate key feature points of the digital human model, thereby improving the efficiency of the testing process and effectively resolving the problem of low efficiency in the prior art.
2. The second data is matched and aligned with the digital human model, and a correspondence is established between the second data and the digital human model through key feature point matching and shape registration, to obtain third data, so as to achieve timely acquisition of the third data after matching, thus enabling accurate and smooth testing and effectively improving the testing efficiency in the testing process.
3. Key feature points are extracted from the third data and optimized through a computer vision algorithm and image processing, and finally morphological parameters are obtained according to the optimized key feature points, so as to reduce errors in the measurement process and the number of measurements, thus improving the efficiency of the measurement process.

### BRIEF DESCRIPTION OF THE DRAWINGS

FIG. 1 is a flowchart of a visual measurement method based on a digital human model according to an embodiment of the present application;

FIG. 2 is a flowchart of visual measurement preparation according to an embodiment of the present application;

FIG. 3 is a grayscale scatter plot of overlap degrees according to an embodiment of the present application; and

FIG. 4 is a schematic structural diagram of a visual measurement system based on a digital human model according to an embodiment of the present application.

### DETAILED DESCRIPTION OF THE EMBODIMENTS

The embodiments of the present application provide a visual measurement method and system based on a digital human model, to addresses the problem of low efficiency in the testing process in the prior art. A digital human model is constructed from obtained 3D data, pose estimation is performed on the digital human model using a deep learning algorithm to obtain first data, and the first data is preprocessed to obtain second data. Then, the second data is matched and aligned with the digital human model, and a correspondence between the second data and the digital human model is established through key feature point matching and shape registration, to obtain third data. Key feature points are extracted from the third data and optimized through a computer vision algorithm and image processing, and finally, morphological parameters are obtained according to the optimized key feature points. The present application improves the efficiency of the testing process.

The technical solutions in the embodiments of the present application are intended to solve the above problem of low efficiency in the testing process. A general idea is as follows:

A digital human model is constructed from obtained 3D data, pose estimation is performed on the digital human model to obtain first data, and the first data is preprocessed to obtain second data. Then, the second data is matched and aligned with the digital human model, and a correspondence between the second data and the digital human model is established through key feature point matching and shape registration, to obtain third data. Finally, key feature points are extracted from the third data and optimized, and morphological parameters are obtained according to the optimized key feature points. The present application improves the efficiency of the testing process.

For a better understanding of the foregoing technical solutions, the following describes the foregoing technical solutions in detail with reference to the accompanying drawings and specific implementations.

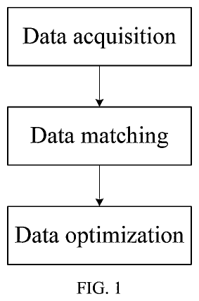

FIG. 1 is a flowchart of a visual measurement method based on a digital human model according to an embodiment of the present application. The method includes the following steps: S1: A digital human model is constructed according to obtained 3D data, pose estimation is performed on the digital human model using a deep learning algorithm to obtain first data, and the first data is preprocessed to obtain second data. The first data is used to describe a pose of the digital human model in 3D space, and the second data is the preprocessed first data. The digital human model is used for virtual simulation of a digital human image, and pose estimation refers to positioning of key points of the digital human model. S2: The second data is matched and aligned with the digital human model, and a correspondence is established between the second data and the digital human model through key feature point matching and shape registration, to obtain third data. Key feature point matching refers to finding feature points of the second data through computer vision and matching corresponding key feature points of the digital human model. Shape registration refers to comparing the second data with the digital human model and obtaining a similarity between the second data and the digital human model. The third data refers to the image data obtained after aligning the second data with the digital human model. S3: The key feature points are extracted from the third data and optimized through a computer vision algorithm and image processing, and finally morphological parameters are obtained according to the optimized key feature points. The key feature points include facial feature points and skeletal connection points. The morphological parameters include basic data such as the height and weight, as well as determining of the model pose.

In this embodiment, the feature points can be obtained through deep learning and directly preprocessed. The preprocessed key feature points can then be matched through computer vision, while simultaneously optimized to reduce repeated matching operations. This greatly shortens the testing time, reduces the error rate, and significantly decreases the number of correction operations that require returning to the previous step. The step optimization and algorithm optimization in the testing process ensure both the accuracy and authenticity of the test, while also improving testing efficiency.

Further, said obtaining first data includes the following steps: A preset data set is constructed based on existing data, where the existing data includes morphological measurement data, facial feature data, and motion and expression data, and the preset data set is a set of digital human model images with preset poses and corresponding pose annotation information. A preset model is trained and predicted using the constructed preset data set, to obtain a prediction result of the model pose estimation. The preset model has the function of deep learning, and the prediction result of the model pose estimation represents a difference between the prediction result of the preset model and pose annotation, as measured using a loss function. After the training, pose information of the digital human model is input into the trained preset model, and predicted key feature points are outputted, to obtain the first data.

In this embodiment, the morphological measurement data refers to specific data obtained during morphological measurement of the digital human model, and primarily describes the external contour, structure, size, and morphological features of the digital human model. The facial feature data includes the facial contour, shape of the facial features, expression features, and the texture of the facial skin of the digital human model. The predicted key feature points are critical position points that reflect the shape and pose of the digital human. By accurately annotating and measuring the points, precise control and adjustment of the digital human model can be achieved, thereby improving testing efficiency.

Further, said constructing a digital human model specifically includes the following steps: A basic image of the digital human model is designed using 3D modeling software, where the basic image includes the shape, contour, proportion and details. Texture mapping processing is performed on the digital human model, where the texture mapping processing includes adding colors, materials, and textures. Key feature point binding is performed on the digital human model to create a corresponding motion mode and motion range, and positions and weights of the key feature points in the digital human model are adjusted during the key feature point binding, where the weight is a parameter for quantifying an influence degree of the key feature point on the digital human model. Expression animation corresponding to the digital human model is added using 3D animation software, and rendering enhancement is performed on the digital human model using preset rendering settings, where the preset rendering settings include adjusting lighting, adjusting shadows, adding background, and adding environment.

In this embodiment, key feature point binding for the digital human model involves selecting an algorithm based on weight drawing to ensure that the selected algorithm supports the selected key feature points and can achieve smooth and natural deformation effects. The key feature points are associated with corresponding parts of the model to ensure that each feature point is accurately bound to the corresponding part of the model, and that the expected deformation effect can be achieved. After completing the feature point binding, a preview and adjustment of the binding effect are performed. The model deformation is observed by moving the key feature points. If errors in the deformation are found, it is necessary to return to the previous step for adjustment and optimization. The adjustment includes modifying the weight distribution, reselecting the feature points, and adjusting binding parameters. The optimization step significantly improves the efficiency of the testing process.

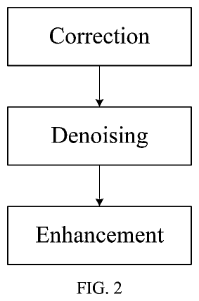

Further, FIG. 2 is a flowchart of visual measurement preparation according to an embodiment of the present application. Said preprocessing includes denoising, enhancement, and correction. The denoising includes weakening a noise component in the first data using a machine learning algorithm; the enhancement includes improving contrast, brightness, and clarity of the first data through sharpening, to increase a proportion of high-frequency components in the first data; and the correction includes correcting the first data through radiation correction to eliminate distortion and errors of the first data.

In this embodiment, denoising is used to collect data and analyze noise characteristics in the data. Through a denoising algorithm, noise in the data is removed. Denoising can make the image sharper, and enhancement can significantly improve the accuracy of the image. Tasks can be automated to increase efficiency while reducing human errors, thus improving the reliability of the results. Correction eliminates errors and biases, significantly improving the testing precision. Additionally, by reducing the repetitive work and repair costs caused by errors, time and resources can be saved, ultimately improving the overall testing efficiency. Further, the contrast is calculated using the following formula:

$$C = \frac{1}{M * N} * {\sum }_{i = 1}^{F} {\sum }_{j = 1}^{H} [ \sqrt{{( Δ {x}_{ij} )}^{2} + ( Δ {y}_{ij}^{2} )} ] ;$$

C is the contrast, M is a pixel width of the first data, N is a pixel height of the first data, ΔXᵢⱼ is a difference of a gradient value of a pixel (i, j) in the first data in a horizontal direction, ΔYᵢⱼ is a difference of a gradient value of the pixel (i, j) in the first data in a vertical direction, i is a number of the pixel in the first data in the horizontal direction, i=1, 2, 3, . . . , F, F is a total number of pixels in the first data in the horizontal direction, j is a number of the pixel in the first data in the vertical direction, j=1, 2, 3, . . . , H, and H is a total number of the pixels in the first data in the vertical direction.

In this embodiment, an image processing library is used to read pixel data and determine the coordinates of the to-be-retrieved pixel in the image, based on the x and y coordinates, with (0, 0) set as the top-left corner. A color value of a pixel at a specified position is read to reflect the image contrast through a dispersion degree of the pixel intensity distribution. Using the contrast calculation method, the intensity differences between adjacent pixels or across the entire image are calculated. The differences reflect the variations in light and dark across different regions of the image, achieving enhanced visual details, improved depth perception, better clarity, and optimized lighting effects. This results in fewer corrections and debugging in subsequent tests, thereby improving the efficiency of the testing process.

Further, the gradient value is calculated using the following formula:

$$G ( i , j ) = \sqrt{{\sum }_{d ∈ D} {\vert f [ K ( i , j ) - K ( p + {d}_{y} , q + {d}_{x} ) ] \vert}^{h}} ;$$

G(i, j) is the gradient value of the pixel (i, j) in the first data, D is a direction set of the pixels in the first data, d is a direction of the pixel in the first data, i is an abscissa of the pixel in the first data, j is an ordinate of the pixel in the first data, dx is an x component of the pixel in a d^{th} direction in the first data, d_{y} is a y component of the pixel in the d^{th} direction in the first data, and h is a preset factor.

In this embodiment, the preset factor h is set to ensure that the data under the square root in the gradient value calculation formula is positive, thus ensuring the authenticity and usability of the calculation. h is defined as an extremely small positive real number within the range of 0 to 1. Since the output of the gradient value cannot be calculated through linear superposition, the function f is defined as a nonlinear function. The use of h ensures the stability and convergence of the nonlinear calculation. By calculating the gradient value through the vector of the pixel, the model parameters can be adjusted more accurately, improving the prediction accuracy of the digital human model. Additionally, the learning rate can be adjusted based on the magnitude of the gradient value, further enhancing the efficiency of the testing process.

Further, said matching and aligning the second data with the digital human model specifically includes the following steps: Preset feature points are generated through the digital human model, where the preset feature points correspond to the key feature points. Feature point matching is performed on feature points in the second data using a feature matching algorithm and the preset feature points, where the feature point matching represents matching between the feature points in the second data and the preset feature points. Spatial transformation is performed on the digital human model according to a result of the feature point matching, where the spatial transformation includes translation, rotation, and scaling, and the spatial transformation is used to align the digital human model with a pose and position corresponding to the second data. A pose and shape of the digital human model are adjusted using a 3D deformation method and an optimization algorithm.

In this embodiment, the feature points can be automatically extracted using computer vision and image processing techniques. By analyzing the texture, edges, and contour information of the model, the positions of the feature points can be automatically recognized and located. In the digital human model, the feature points represent key parts of the model. Feature point matching and alignment enable high-precision localization. By matching the feature points correspondingly, the position and orientation of the digital human model in 3D space can be accurately determined. Automating the feature point matching and alignment process simplifies the creation of the digital human model, significantly improving the efficiency of the testing process.

Further, said extracting and optimizing key feature points specifically includes the following steps: A preset area and positions of preset feature points are obtained using a target detection method, and the preset feature points are filtered and corrected with reference to structural information of the digital human model and priori knowledge. Filtering and correcting are used to exclude false positives and missed detections of the preset feature points. The preset feature points are extracted again using a convolutional neural network model, and the digital human model is trained to learn representation and positioning methods of the key feature points to enable recognition of the key feature points by the digital human model. An overlap degree between the key feature points is detected using a non-maximum suppression method, to remove redundancy and overlap, and accuracy and reliability of the extracted key feature points are verified and evaluated by using a preset data set.

In this embodiment, the feature points are initially extracted from the digital human model based on a preset algorithm to represent the basic morphology and motions of the model. Using structural information analysis and the results of applying the priori knowledge, the initially extracted feature points are corrected and optimized, including adjustments to the position, quantity, and type of the feature points. Convolutional layers of the convolutional neural network are then used for feature extraction to ensure a more accurate reflection of morphology and action characteristics of the digital human model. This reduces the need for re-extraction and re-testing, significantly improving the efficiency of the testing process.

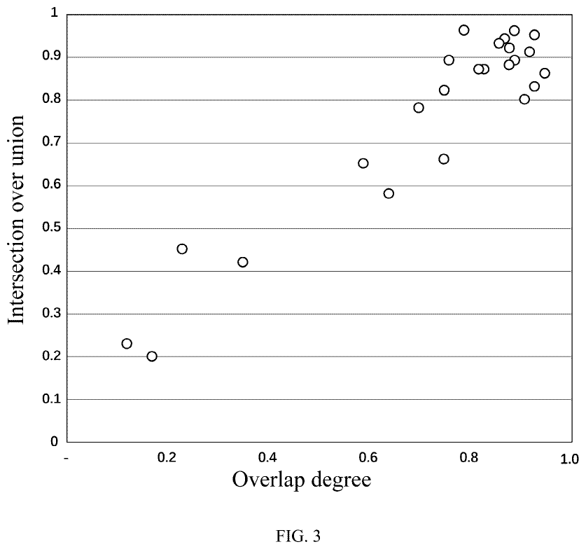

Further, FIG. 3 is a grayscale scatter plot of overlap degrees according to an embodiment of the present application. The non-maximum suppression method includes the following steps: Detection boxes generated after applying a convolutional neural network are ranked based on confidence, a preset detection box is selected as a current suppression object, and an overlap degree between each remaining detection box and the current suppression object is calculated, where the overlap degree is calculated using the following formula:

$${R}_{g} = {S}_{g} + \frac{{\sum }_{g = 1}^{G} exp [ - \frac{{( {d}_{g} )}^{2}}{2 {σ}^{2}} ]}{G} + cos {θ}_{g} ;$$

R_{g} is an overlap degree between a g^{th} remaining detection box and the current suppression object, Sg is an intersection over union between the g^{th} remaining detection box and the current suppression object, g is a number of the remaining detection box, g=1, 2, 3, . . . , G, G is a total number of the remaining detection boxes, d_{g} is a distance between the current suppression object and the g^{th} remaining detection box, σ is a standard deviation of a Gaussian kernel, and θ_{g} is a distance-angle relationship between the current suppression object and the g^{th} remaining detection box.

In this embodiment, the change statistics table of the overlap degrees is shown in Table 1

TABLE 1
Change Statistics Table of Overlap Degrees

| | | | Distance- | Standard | |
|---|---|---|---|---|---|
| Overlap | Intersection | | angle | deviation of | |
| degree | over union | Distance | relationship | the Gaussian | Total |
| R_{g} | S_{g} | d_{g}/Pixel | θ_{g} | kernel | quantity G |
| 0.87 | 0.8 | 0.83 | $\frac{1}{2}$ | 0.8 | 20 |
| 0.78 | 0.7 | 0.96 | $\frac{2}{3}$ | 0.9 | 20 |
| 0.82 | 0.75 | 0.92 | $- \frac{1}{2}$ | 0.8 | 20 |
| 0.91 | 0.92 | 0.89 | $- \frac{4}{5}$ | 0.9 | 20 |
| . . . | . . . | . . . | . . . | . . . | . . . |

In this embodiment, the overlap degree cannot be directly obtained from a single piece of data. It requires comprehensive analysis of the overlap degree, intersection over union, distance, distance-angle relationship, standard deviation of the Gaussian kernel, and total number of detection boxes for the remaining detection boxes and the current suppression object. For example, the distance of the first group of data is smaller than that if the second group of data, but the final overlap degree is larger. The standard deviation of the Gaussian kernel in the second group of data is larger than in the third group of data, but the final overlap degree is smaller. Thus, a comprehensive analysis is necessary. From the grayscale scatter plot of overlap degrees in the figure, it can be observed that the distribution of scatter points is close to a straight line and shows an upward trend, indicating a high and positive correlation between the intersection over union and the overlap degree. By calculating the overlap degree, the accuracy of the key feature points can be more accurately grasped, which helps control the number of repeated operations, and also ensures the effective extraction of the key feature points, allowing for targeted optimization measures. Furthermore, by calculating the overlap degree, testing time can be effectively reduced, thereby further improving the testing efficiency.

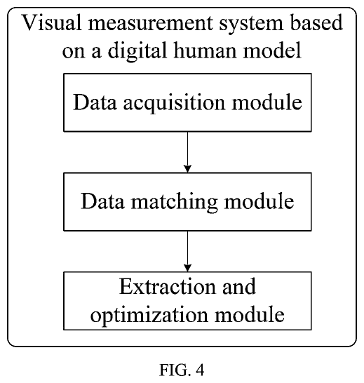

Further, FIG. 4 is a schematic structural diagram of a visual measurement system based on a digital human model according to an embodiment of the present application. The visual measurement system based on a digital human model includes a data acquisition module, a data matching module, and an extraction and optimization module. The data acquisition module is configured to construct a digital human model according to obtained 3D data, perform pose estimation on the digital human model using a deep learning algorithm to obtain first data, and preprocess the first data to obtain second data. The first data is used to describe a pose of the digital human model in 3D space, and the second data is the preprocessed first data. The digital human model is used for virtual simulation of a digital human image, and pose estimation refers to positioning of key points of the digital human model. The data matching module is configured to match and align second data with the digital human model, and establish a correspondence between the second data and the digital human model through key feature point matching and shape registration, to obtain third data. Key feature point matching refers to finding feature points of the second data through computer vision and matching corresponding key feature points of the digital human model. Shape registration refers to comparing the second data with the digital human model and obtaining a similarity between the second data and the digital human model. The third data refers to the image data obtained after aligning the second data with the digital human model. The extraction and optimization module is configured to extract the key feature points from the third data and optimize same through a computer vision algorithm and image processing, and finally obtain morphological parameters according to the optimized key feature points. The key feature points include facial feature points and skeletal connection points. The morphological parameters include basic data such as the height and weight, as well as determining of the model pose.

In this embodiment, pose estimation is performed on the digital human model using the deep learning algorithm, and the data is preprocessed and then matched and aligned with the digital human model to establish a correspondence with the digital human model. Finally, the key feature points are extracted and optimized using the computer vision algorithm. Through a plurality of optimization steps, the efficiency of the testing process is improved

In summary, according to the embodiments of the present application, pose estimation is performed on the digital human model using the deep learning algorithm to obtain the first data, and the first data is preprocessed to obtain the second data, so as to quickly locate the key feature points of the digital human model, thereby improving the efficiency of the testing process and effectively resolving the problem of low efficiency in the prior art.

A person skilled in the art should understand that the embodiments of the present disclosure may be provided as a method, a system, or a computer program product. Therefore, the present disclosure may use a form of hardware only embodiments, software only embodiments, or embodiments with a combination of software and hardware. Moreover, the present disclosure may use a form of a computer program product that is implemented on one or more computer-usable storage media (including but not limited to a magnetic disk memory, a compact disc read-only memory (CD-ROM), an optical memory, and the like) that include computer-usable program code.

The present disclosure is described with reference to the flowcharts and/or block diagrams of the method, the device (system), and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a processor of a general-purpose computer, a special-purpose computer, an embedded processor, or other programmable data processing devices to produce a machine, such that instructions executed by the processor of the computer or other programmable data processing devices produce an apparatus used for implementing a function specified in one or more flows of the flowchart and/or one or more blocks of the block diagram.

These computer program instructions may also be stored in a computer readable memory that can guide a computer or other programmable data processing devices to work in a specific manner, such that the instructions stored in the computer readable memory produce an article of manufacture including an instruction device, and the instruction device implements the functions specified in one or more flows of the flowchart and/or one or more blocks in the block diagram.

These computer program instructions may alternatively be loaded onto a computer or another programmable data processing device, such that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

Although some preferred examples of the present disclosure have been described, persons skilled in the art can make changes and modifications to these examples once they learn the basic inventive concept. Therefore, the appended claims are intended to be construed to include the preferred examples and all alterations and modifications that fall within the scope of the present disclosure.

Obviously, those skilled in the art can make various changes and modifications to the present disclosure without departing from the spirit and scope of the present disclosure. In this way, if these modifications and variations of the present disclosure fall within the scope of the claims of the present disclosure and equivalent technologies thereof, the present disclosure is further intended to include these modifications and variations.

What is claimed is:

1. A visual measurement method based on a digital human model, comprising the following steps:
S1: constructing a digital human model according to obtained three-dimensional (3D) data, performing pose estimation on the digital human model to obtain first data, and preprocessing the first data to obtain second data;
S2: matching and aligning the second data with the digital human model, and establishing a correspondence between the second data and the digital human model through key feature point matching and shape registration, to obtain third data; and
S3: extracting key feature points from the third data and optimizing the key feature points, and finally obtaining morphological parameters according to the optimized key feature points.

2. The visual measurement method based on a digital human model according to claim 1, wherein said obtaining first data comprises the following steps:
constructing a preset data set based on existing data, wherein the existing data comprises morphological measurement data, facial feature data, and motion and expression data, and the preset data set is a set of digital human model images with preset poses and corresponding pose annotation information;
training and predicting a preset model using the constructed preset data set, to obtain a prediction result of the model pose estimation; and
after the training, inputting pose information of the digital human model into the trained preset model, and outputting predicted key feature points, to obtain the first data.

3. The visual measurement method based on a digital human model according to claim 1, wherein said constructing a digital human model specifically comprises the following steps:
designing a basic image of the digital human model using 3D modeling software, and performing texture mapping processing on the digital human model, wherein the texture mapping processing comprises adding colors, materials, and textures;
performing key feature point binding on the digital human model to create a corresponding motion mode and motion range, and adjusting positions and weights of the key feature points in the digital human model during the key feature point binding, wherein the weight is a parameter for quantifying an influence degree of the key feature point on the digital human model; and
adding expression animation corresponding to the digital human model using 3D animation software, and performing rendering enhancement on the digital human model using preset rendering settings, wherein the preset rendering settings comprise adjusting lighting, adjusting shadows, adding background, and adding environment.

4. The visual measurement method based on a digital human model according to claim 1, wherein said preprocessing comprises denoising, enhancement, and correction;
the denoising comprises weakening a noise component in the first data using a machine learning algorithm;
the enhancement comprises improving contrast, brightness, and clarity of the first data through sharpening, to increase a proportion of high-frequency components in the first data; and
the correction comprises correcting the first data through radiation correction to eliminate distortion and errors of the first data.

5. The visual measurement method based on a digital human model according to claim 4, wherein the contrast is calculated using the following formula:
$$C = \frac{1}{M * N} * {\sum }_{i = 1}^{F} {\sum }_{j = 1}^{H} [ \sqrt{{( Δ {x}_{ij} )}^{2} + ( Δ {y}_{ij}^{2} )} ] ;$$
C is the contrast, M is a pixel width of the first data, N is a pixel height of the first data, ΔXᵢⱼ is a difference of a gradient value of a pixel (i, j) in the first data in a horizontal direction, ΔYᵢⱼ is a difference of a gradient value of the pixel (i, j) in the first data in a vertical direction, i is a number of the pixel in the first data in the horizontal direction, i=1, 2, 3, . . . , F, F is a total number of pixels in the first data in the horizontal direction, j is a number of the pixel in the first data in the vertical direction, j=1, 2, 3, . . . , H, and H is a total number of the pixels in the first data in the vertical direction.

6. The visual measurement method based on a digital human model according to claim 5, wherein the gradient value is calculated using the following formula:
$$G ( i , j ) = \sqrt{{\sum }_{d ∈ D} {\vert f [ K ( i , j ) - K ( p + {d}_{y} , q + {d}_{x} ) ] \vert}^{h}} ;$$
G(i, j) is the gradient value of the pixel (i, j) in the first data, D is a direction set of the pixels in the first data, d is a direction of the pixel in the first data, i is an abscissa of the pixel in the first data, j is an ordinate of the pixel in the first data, dx is an x component of the pixel in a d^{th} direction in the first data, d_{y} is a y component of the pixel in the d^{th} direction in the first data, and h is a preset factor.

7. The visual measurement method based on a digital human model according to claim 1, wherein said matching and aligning the second data with the digital human model specifically comprises the following steps:
generating preset feature points through the digital human model, wherein the preset feature points correspond to the key feature points, and performing feature point matching on feature points in the second data using a feature matching algorithm and the preset feature points, wherein the feature point matching represents matching between the feature points in the second data and the preset feature points;
performing spatial transformation on the digital human model according to a result of the feature point matching, wherein the spatial transformation comprises translation, rotation, and scaling, and the spatial transformation is used to align the digital human model with a pose and position corresponding to the second data; and
adjusting a pose and shape of the digital human model using a 3D deformation method and an optimization algorithm.

8. The visual measurement method based on a digital human model according to claim 1, wherein said extracting and optimizing key feature points specifically comprises the following steps:
obtaining a preset area and positions of preset feature points using a target detection method, and filtering and correcting the preset feature points with reference to structural information of the digital human model and priori knowledge;
extracting the preset feature points again using a convolutional neural network model, and training the digital human model to learn representation and positioning methods of the key feature points to enable recognition of the key feature points by the digital human model; and
detecting an overlap degree between the key feature points using a non-maximum suppression method, to remove redundancy and overlap, and verifying and evaluating accuracy and reliability of the extracted key feature points by using a preset data set.

9. The visual measurement method based on a digital human model according to claim 8, wherein the non-maximum suppression method comprises the following steps:
ranking, based on confidence, detection boxes generated after applying a convolutional neural network, selecting a preset detection box as a current suppression object, and calculating an overlap degree between each remaining detection box and the current suppression object, wherein
the overlap degree is calculated using the following formula:
$${R}_{g} = {S}_{g} + \frac{{\sum }_{g = 1}^{G} exp [ - \frac{{( {d}_{g} )}^{2}}{2 {σ}^{2}} ]}{G} + cos {θ}_{g} ;$$
R_{g} is an overlap degree between a g^{th} remaining detection box and the current suppression object, Sg is an intersection over union between the g^{th} remaining detection box and the current suppression object, g is a number of the remaining detection box, g=1, 2, 3, . . . , G, G is a total number of the remaining detection boxes, d_{g} is a distance between the current suppression object and the g^{th} remaining detection box, σ is a standard deviation of a Gaussian kernel, and θ_{g} is a distance-angle relationship between the current suppression object and the g^{th} remaining detection box.

10. A visual measurement system based on a digital human model, comprising a data acquisition module, a data matching module, and an extraction and optimization module, wherein
the data acquisition module is configured to construct a digital human model according to obtained three-dimensional (3D) data, perform pose estimation on the digital human model to obtain first data, and preprocess the first data to obtain second data;
the data matching module is configured to match and align the second data with the digital human model, and establish a correspondence between the second data and the digital human model through key feature point matching and shape registration, to obtain third data; and
the extraction and optimization module is configured to extract key feature points from the third data and optimize same, and finally obtain morphological parameters according to the optimized key feature points.
